(19) United States
(12) Patent Application Publication
(10) Pub. No.: US 2021/0120836 A1
(43) Pub. Date: Apr. 29, 2021

(54) FERMENTED WHEY BEVERAGE AND METHOD OF MAKING THE SAME

(71) Applicant: The Spare Food Co., New York, NY (US)

(72) Inventors: Adam D. Kaye, Mamaroneck, NY (US); Jeremy Kaye, Dobbs Ferry, NY (US)

(21) Appl. No.: 17/078,808

(22) Filed: Oct. 23, 2020

Related U.S. Application Data
(60) Provisional application No. 63/070,729, filed on Aug. 26, 2020.
(60) Provisional application No. 62/924,841, filed on Oct. 23, 2019.

(51) Int. Cl. A23C 21/02; A23C 3/02; A23C 3/04; C12H 3/02

(52) U.S. Cl. CPC A23C 21/026; A23C 3/02; A23Y 2220/00; C12H 3/02; A23C 3/04

(57) ABSTRACT

A method of preserving a flavor profile of a fermented beverage and controlling an alcohol content within the fermented beverage are provided. A desired alcohol content for the fermented beverage may be determined. The fermented beverage may be flash pasteurized to kill substantially all of a yeast used utilized for fermenting the fermented beverage. The flash pasteurized fermented beverage may be rapidly chilled.

### CROSS-REFERENCE TO RELATED APPLICATIONS

This application claims the benefit of U.S. provisional patent application Ser. No. 63/070,729, entitled “Spare Tonic Process,” filed Aug. 26, 2020, and also claims the benefit of U.S. provisional patent application Ser. No. 62/924,841, entitled “Naturally Effervescent Whey Beverage,” filed Oct. 23, 2019, the entire contents of both of which are incorporated herein by reference.

### TECHNICAL FIELD

The present disclosure generally relates to beverages, and more particularly relates to fermented beverages.

### BACKGROUND

Production of various fermented milk products may result in the production whey as a by-product. Generally, whey, as a by-product from making fermented milk products, is generally classified as either sweet whey or acid whey. Sweet whey is typically a by-product of making hard or rennet cheeses. Acid whey is typically a by-product of making filtered yogurt, cottage cheese, as well as some other types of cheeses and fermented milk products.

Whey is believed to provide a variety of potential health benefits. For example, native whey proteins may stimulate immunity and protect against cancer. Intestinal immunity and beneficial intestinal bacteria may be greatly benefitted by whey, which may be consumed as a food by the intestinal bacteria. Whey has also been observed to help increase the tolerance of infants to formulas based on soy or cow's milk and lessens the associated colic and allergic reactions. Whey is also believed to be beneficial for the heart, liver, kidneys and intestines. Whey has been recommended and used therapeutically in hepatitis, skin conditions, infections, edema, arthritis and rheumatism.

### SUMMARY

According to an implementation, a method of preserving a flavor profile of a fermented beverage may include determining a desired alcohol content for the fermented beverage. The method may also include flash pasteurizing the fermented beverage to substantially kill a yeast used utilized for fermenting the fermented beverage. The method may further include rapidly chilling the flash pasteurized fermented beverage.

One or more of the following features may be included. The desired alcohol content may be below about 0.5% alcohol by volume (ABV). Flash pasteurizing the fermented beverage may terminate the fermentation process. The fermented beverage may contain lactic acid bacteria, and flash pasteurizing the fermented beverage does not kill at least a portion of the lactic acid bacteria. Flash pasteurizing the fermented beverage may not kill a majority of the lactic acid bacteria.

The fermented beverage may include a fermented diary-based beverage, and flash pasteurizing the beverage does not cook the fermented beverage. The fermented beverage may be a fermented acid whey beverage. Rapidly chilling the fermented beverage may prevent spoiling of the dairy-based beverage.

Flash pasteurizing the fermented beverage may include maintaining the fermented beverage at a temperature of about 160 degrees F. for about 15 seconds. Rapidly chilling the fermented beverage may include rapidly chilling the fermented beverage to a temperature of about 45 degrees F. The method may include subsequently chilling the fermented beverage to a temperature of about 41 degrees F.

According to another implementation, a method for controlling an alcohol content in a beverage may include fermenting a beverage base, and determining that the fermented beverage base has achieved a desired alcohol content. The method may further include flash pasteurizing the beverage base to substantially kill a yeast utilized for fermenting the beverage base.

One or more of the following features may be included. The beverage base may include acid whey. Flash pasteurizing the beverage base may not cook the acid whey. The method may further include rapidly cooling the pasteurized beverage base to a temperature of about 45 degrees F. The method may further include cooling the pasteurized beverage base to a temperature of about 41 degrees F.

The desired alcohol content may be below about 0.5% alcohol by volume (ABV). Fermenting the beverage base may include generating lactic acid bacteria within the beverage base. Flash pasteurizing the beverage may not kill at least a portion of the lactic acid bacteria within the beverage base. Flash pasteurizing the beverage base may include heating the beverage base to a temperature of about 160 degrees F. for about 15 seconds.

### BRIEF DESCRIPTION OF THE DRAWINGS

FIG. 1 is a flow chart depicting an example embodiment of a process for making a fermented beverage;

FIG. 2 is a flow chart depicting an example embodiment of a fermentation process that may be used in connection with making a fermented beverage;

FIG. 3 is a flow chart depicting an example embodiment of a process for arresting fermentation that may be used connection with making a fermented beverage; and

FIG. 4 is a flow chart depicting an example embodiment of filtration process that may be used in connection with making a fermented beverage.

### DETAILED DESCRIPTION OF EXAMPLE EMBODIMENTS

In general, the present disclosure may provide a fermented beverage and various processes associated with producing and handling the fermented beverage. Consistent with some implementations, the fermented beverage may be produced, in part, through the fermentation of acid whey. Consistent with some embodiments, the present disclosure may provide a sparkling, probiotic beverage made, at least in part, from acid whey. In some implementations, the beverage may include and/or provide probiotic characteristics and/or ingredients, and may provide a source of various vitamins and minerals, such as magnesium, calcium, vitamins B2, B6, and B12. Accordingly, in some implementations, the beverage may, in some individuals, provide and/or support beneficial intestinal bacterial, which may support an individual's immune system, as well as providing various additional and/or alternative health benefits.

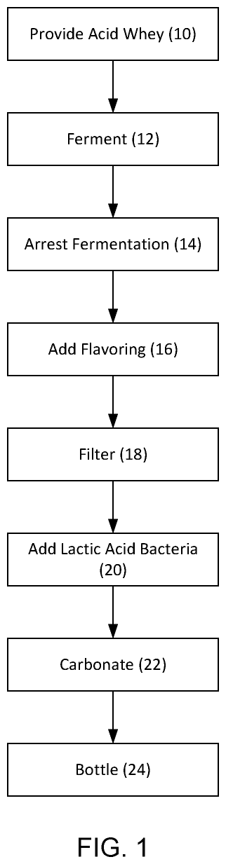

Consistent with an illustrative example embodiment, a fermented beverage may be provided. As generally discussed above, consistent with an example embodiment, the fermented beverage may include a fermented acid whey beverage. For example, and with reference to FIG. 1, in general, producing the fermented beverage may include providing 10 acid whey and fermenting 12 the acid whey. Additionally, the fermentation of the acid whey may be arrested 14, and flavoring may be added 16 to the fermented acid whey.

In general, acid whey may include a by-product of the manufacture of filtered yogurt, strained yogurt, some types of cheeses, as well as various other fermented milk products. For example, typically the production of filtered yogurt, such as Greek-style yogurt may only utilize approximately about 25% to about 35% of the milk. The remainder of the milk, which is not retained as part of the filtered yogurt product, may be acid whey. While Greek-style yogurt has been specifically identified as a type of filtered yogurt, it will be appreciated that various other filtered yogurts, cottage cheese, various other cheeses, and/or other fermented dairy products may similarly result in acid whey as a by-product of the manufacturing process. Acid whey from other such dairy products may equally be utilized.

Consistent with some implementations, the acid whey by-product of the dairy product (e.g., Greek-style yogurt, etc.) manufacture may be acquired from the dairy product manufacturing process. For example, acid whey may be acquired from a strained yogurt manufacturer, and may be held at cold, food-safe temperatures for storage and transport to be used as a beverage base for a fermented beverage consistent with some aspects of the present disclosure. As will be appreciated the acid whey (also referred to herein as a “beverage base”), may be fermented 12 as part of providing a fermented beverage consistent with some implementation of the present disclosure. The resulting fermented beverage may, in some implementations, be a protein rich drink, retaining much, if not all, of the protein from the original acid whey beverage base.

In some example embodiments, fermenting the acid whey may reduce the amount of lactose in the resultant fermented beverage. For example, as a sugar, the lactose present in the acid whey may be at least partially consumed by the fermentation. As such, in some example embodiments, while the resulting fermented beverage may not be lactose free, the fermented beverage may have a lower lactose content than the original acid whey beverage base. In some instances, the acid whey, which may itself be a by-product of a fermentation process (e.g., which may be part of filtered yogurt manufacturing), may include various bacteria which may be beneficial to the intestinal health of an individual consuming the acid whey. In some example embodiments, at least a portion of such beneficial bacteria may be retained during fermentation 12 of the acid whey. Additionally, in some example embodiments, the fermentation of the acid whey may result in the generation of various forms of bacteria, such as lactic acid bacteria, which may have beneficial effect on the intestinal health of an individual consuming the beverage. Further, in some example embodiments, the fermentation of the acid whey may result in the production of carbon dioxide. In some instances, at least a portion of the carbon dioxide may become entrained in the fermented acid whey beverage, and may result in a pleasant natural effervescence in the fermented beverage.

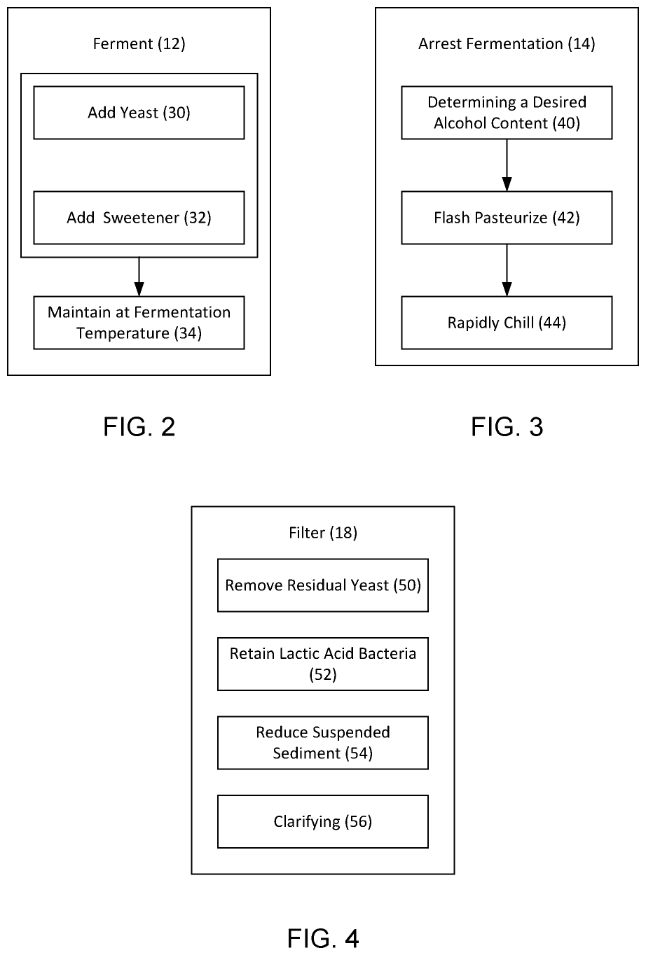

Consistent with an illustrative example embodiment, and referring also to FIG. 2, fermenting 12 the acid whey may include adding 30 yeast to the acid whey. As is generally known, yeast may, at least in part, initiate, facilitate, and/or promote fermentation. It will be appreciated that a wide variety of yeast strains may be suitably utilized for fermenting 12 the acid whey. Consistent with the present disclosure, a number of considerations may be relevant to the selection of a particular yeast strain. For example, acid whey may generally have a pH of around 4.2-4.5 (although other pH's may be exhibited depending, for example, on the exact nature of the dairy product and manufacturing process of which the acid whey is a by-product). As such, a suitable yeast may be selected that may be capable of initiating, facilitating, and/or promoting fermentation within the pH range of the acid whey. Additionally, in some instances, in selecting a yeast to be added 30 to the acid whey, the flavor, or flavor profile, which may be imparted on the final fermented product by the yeast may be considered. Various additional and/or alternative objective and/or subjective factors may be considered in selecting a suitable yeast for use in fermenting 12 the acid whey. In some particular embodiments, strains of yeast that are commonly used in the production of alcoholic beverages may be utilized. In one particular illustrative example embodiment, the yeast product Lalvin DV10, available from Scott Laboratories Inc. may be utilized for fermenting the acid whey. Consistent with some embodiments, Lalvin DV10 may generally be a relatively fast fermenter, e.g., which may result in a relatively shorter fermentation time for the acid whey. Lalvin DV10 may exhibit a relatively neutral sensory effect, in that it may not add much additional flavor to the final fermented beverage, e.g., which may allow other flavors, inherent in the acid whey and/or added as part of the fermented beverage, to be more pronounced. Lalvin DV10 may exhibit various additional desirable characteristics. It will be appreciated that various additional and/or alternative yeast strains (and/or combinations of strains) may also be suitably utilized.

Consistent with some embodiments, fermenting 12 the acid whey may also include adding 32 a sweetener to the acid whey. As is generally known, sweeteners (e.g., a sugars), particularly in combination with yeast, may promote, support, and/or facilitate fermentation. Accordingly, adding 32 a sweetener to the acid whey, particularly in combination with the added 30 yeast, may facilitate and/or promote efficient fermentation of the acid whey. It will be appreciated that a variety of sweeteners may be suitably utilized, including, but not limited to, honey, cane sugar, high fructose corn syrup, agave nectar, beet sugar, as well as any other sweetener that may aid in initiating, promoting, supporting, or otherwise facilitating fermentation of the acid whey. In one particular example embodiment honey may be utilized as a sweetener. For example, honey may, in addition to supporting, promoting, and/or facilitating fermentation, honey may provide a desirable flavor or flavor profile in the final fermented beverage, may provide a desirable coloring to the final fermented beverage, and/or may provide additional healthful benefits to the final fermented beverage, as often may be attributed to honey.

As may be generally known, fermentation may, at least in part, include the conversion of sugars to alcohol. As such, fermentation of the acid whey may result in some degree of alcohol production and inclusion in the final fermented beverage. In general, the amount of alcohol produced may be, at least in part, related to the quantity of food (e.g., sugar) available to the yeast and/or bacteria participating the in the fermentation. Accordingly, in some example embodiments, adding 32 the sweetener to the acid whey may include adding a quantity of the sweetener based on a desired final alcohol content of the resulting fermented beverage. Consistent with one illustrative example embodiment, it may be desirable to market and/or sell the fermented beverage as a non-alcoholic beverage. Consistent with Food and Drug Administration regulations, a product may only be sold as “non-alcoholic” if the product includes less than 0.5% alcohol by volume (ABV). Accordingly, in some example embodiments, the fermented acid whey may be fermented to achieve an alcohol content of less than about 0.5% alcohol by volume (ABV). Consistent with various embodiments, the desired alcohol content for the fermented beverage may be determined, e.g., based, at least in part, on the quantity of sugar added to the acid whey and/or available based on the lactose in the acid whey and the quantity of sugar added to the acid whey. In one such particular embodiment, the sweetener (e.g., such as honey, etc.) may be added to the acid whey at a quantity of about 0.25% of the total batch weight (e.g., which may include the combined weight of the acid whey, the yeast, the sweetener, and any other ingredients included during fermentation). Consistent with such an embodiment, the alcohol content of the fermented beverage may be determined to be less than about 0.5% ABV. While the preceding illustrative example embodiment included an amount of sweetener intended to produce an alcohol content in the fermented beverage of less than about 0.5% ABV, it will be appreciated that other implementations are possible within the scope of the present disclosure, including implementations resulting in an alcoholic final fermented beverage.

Consistent with some embodiments, fermenting 12 the acid whey may include maintaining 34 the acid whey, yeast, and sweetener (as well as any other ingredients that may be present) at a defined fermentation temperature for a defined fermentation period. For example, in a particular implementation, fermenting 12 the acid whey may include heating the acid whey, yeast, and sweetener, and maintaining 34 the mixture at an elevated temperature or a defined fermentation period. For example, as generally discussed above adding 30 the yeast and adding 32 the sweetener to the acid whey may promote, support, and/or facilitate fermentation of the acid whey. As will also be appreciated, carrying out the fermentation at an elevated temperature (e.g., a temperature greater than room temperature) may promote and/or accelerate fermentation of the acid whey. Consistent with some example embodiments, the type of yeast, the defined fermentation period (i.e., how long the fermentation is allowed to proceed), and the fermentation temperature may be calibrated, at least in part, to achieve the desired alcohol content. Further, it will be appreciated that the exact strain, or strains, of yeast selected may, at least in part, influence the temperature at which fermentation is carried out, as different yeast strains may exhibit desirable properties (e.g., speed of fermentation, resulting flavors or flavor profiles in the final fermented beverage, and the like) when fermented at different temperatures. Additionally, it will be appreciated that the defined fermentation period may be based upon, at least in part, the particular yeast strain(s) and the temperature at which fermentation is carried out. Accordingly, the selected yeast strain(s), the selected sweetener, the fermentation temperature, and the fermentation period may be selected to provide one or more of a desired alcohol content, a desired flavor or flavor profile in the final fermented beverage, and a desired total production time for the fermented beverage.

Consistent with one illustrative example embodiment, in which Lalvin DV10 is added 30 as the yeast, and honey is added 32 as the sweetener, in an amount of 0.25% of the total batch weight, fermentation may be carried out by maintaining 34 the mixture at a temperature of about 90 degrees F. for a defined fermentation period of about 18 hours. It will be appreciated that other temperatures and/or fermentation periods may be equally utilized to achieve, e.g., different flavors or flavor profiles in the final fermented beverage, and/or to otherwise vary one or more aspects of the fermented beverage. Consistent with the forgoing illustrative example embodiment, the acid whey may be actively heated from an initial cold storage temperature to around 90 degrees F., with care taken not to materially overshoot the desired temperature. Actively heating the acid whey may reduce the time required to achieve the desired fermentation temperature from the initial cold storage temperature of the acid whey. As the acid whey is being heated, and/or once the acid whey attains the desired fermentation temperature, the yeast and the sweetener may be added to the acid whey. In some instances, for example when honey is utilized as the sweetener, adding the honey later in the heating process (e.g., as the acid whey approaches or reaches the desired fermentation temperature) may facilitate dissolving and/or blending the honey evenly into the acid whey. Further, in some embodiments the honey may be heated (at least partially and/or fully to the desired fermentation temperature) prior to being added to the acid whey. Heating the honey may similarly facilitate even dissolving and/or blending of the honey into the acid whey. Evenly dissolving the sweetener and the yeast into the acid whey may facilitate even and/or optimized fermentation and/or batch-to-batch consistency in the fermentation of the acid whey. According to one particular example embodiment, the acid whey may be fermented for a defined fermentation period of 18 hours. However, it will be appreciated that other fermentation periods may be utilized, e.g., depending upon the yeast utilized, the fermentation period, the desired alcohol content, and the desired flavor or flavor profile of the fermented beverage.

As will be appreciated, dairy production processes that may result in acid whey may, themselves, include fermentation processes. As such, in some embodiments, the acid whey may include various live bacteria cultures, at least some of which may exhibit and/or promote various health benefits. For example, some such live cultures may promote intestinal health. One particular example of such bacteria may include, but is not limited to, lactic acid bacteria. In some implementations, whether the acid whey may, or may not, include lactic acid bacteria, fermenting the acid whey may generate lactic acid bacteria within the fermented acid whey. Such lactic acid bacteria may, in a similar manner as discussed, promote and/or provide various health benefits, such as intestinal health benefits. Further, as generally discussed above, the fermentation of the acid whey may provide a very particular flavor profile for the fermented beverage. The fermentation may also result in some degree of carbon dioxide generation, at least a portion of which may become entrained in the fermented beverage and provide some degree of carbonation and/or effervescence of the fermented beverage. Additionally and/or alternatively, fermentation of the acid whey may, in some implementations, reduce the lactose quantity or content in the final fermented beverage.

Consistent with some implementations, once a desired degree of fermentation is achieved, the fermentation may be arrested 14, e.g., to prevent and/or reduce any subsequent fermentation. Consistent with aspects of some illustrative example embodiments, arresting 14 fermentation may be carried out in a manner to preserve a flavor profile of a fermented beverage and/or to control the alcohol content of a fermented beverage. For example, and as generally described above, fermenting 12 the acid whey may provide a plurality of benefits, such as, but not limited to, the production of beneficial bacteria, providing a lower lactose content in the fermented beverage, providing some degree of effervescence or carbonation. Additionally, fermenting 12 the acid whey may additional result in the production of alcohol, and it may be desirable to control the level of alcohol, e.g., for regulatory reasons, to control the flavor of the fermented beverage, and/or for various additional and/or alternative reasons. For example, consistent with some illustrative example embodiments, in which it may be desirable to sell and/or market the fermented beverage as “non-alcoholic,” it may be desirable to limit the alcohol content to less than about 0.5% ABV. Further, it may be desirable to set, or lock-in, the desired alcohol content without adversely affecting the flavor or flavor profile of the fermented beverage. This may be particularly important when the beverage base that is fermented includes a dairy product, such as acid whey, discussed above.

Consistent with some embodiments, and referring also to FIG. 3, arresting 14 the fermentation of the beverage base (e.g., acid whey) may include determining 40 a desired alcohol content for the fermented beverage. Determining 40 the desired alcohol content for the fermented beverage may include, for example, establishing a quantity of food available for fermentation. For example, the quantity of for available for fermentation may include sweetener added to the beverage base, sugar included within the beverage base (e.g., lactose, in the acid whey), as well as any other components that may be converted to alcohol via the fermentation process. Further, determining the desired alcohol content for the fermented beverage may include defining and/or controlling fermentation parameters, such as, but not limited to, the quantity of yeast utilized to ferment the beverage base, the temperature of fermentation, and the defined fermentation period. In some illustrative example embodiments, determining 40 a desired alcohol content for the fermented beverage may include qualitatively assessing the alcohol content in the fermented beverage at one or more times during the fermentation process (e.g., at the end of the defined fermentation period), e.g., using known chemical assay techniques. Continuing with the above example, determining the desired alcohol content for the fermented beverage may include fermenting the beverage base to achieve less than about 0.5% ABV.

Arresting 14 the fermentation process may include flash pasteurizing 42 the fermented beverage to terminate the fermentation process. Flash pasteurizing 42 the fermented beverage may arrest 14 the fermentation process by killing substantially all of the yeast utilized for fermenting the beverage base. Killing substantially all of the yeast utilized for fermenting the beverage base (e.g., the acid whey), may prevent further fermentation, and, therefore, may prevent further generation of alcohol in the fermented beverage. As such, the desired alcohol content in the fermented beverage may be achieved.

Further, as generally discussed above, the acid whey beverage base may include at least some live bacteria (e.g., lactic acid bacteria) as a result of a fermentation process to produce filtered yogurt, or other dairy product, which produced the acid whey as a by-product. Additionally and/or alternatively, fermenting the beverage base (e.g., acid whey) may include generating lactic acid bacteria within the fermented beverage. Consistent with some embodiments, flash pasteurizing 42 the fermented beverage does not kill at least a portion of the lactic acid bacterial within the fermented beverage. In some embodiments, flash pasteurizing 42 the fermented beverage may not kill a majority of the lactic acid bacteria within the fermented beverage.

Consistent with the foregoing, in some implementations, flash pasteurizing 42 the fermented beverage may include pasteurizing the fermented beverage at a temperature that is high enough, and/or for a time duration that is long enough, to kill substantially all of the yeast to arrest 14 the fermentation process (e.g., to prevent and/or reduce further generation of alcohol within the fermented beverage). Further, flash pasteurizing 42 the fermented beverage may occur at a temperature that is low enough and/or for a time duration that is short enough that at least a portion of the lactic acid bacteria in the fermented beverage may be retained (i.e., may not be killed). Consistent with such embodiments, flash pasteurizing the fermented beverage may utilize a high temperature, short time pasteurization process.

Consistent with some example embodiments, it may be desirable to preserve a flavor or flavor profile of the fermented beverage. That is, it may be desirable that the flash pasteurization of the fermented beverage may not significantly alter the flavor profile of the fermented beverage. For example, as discussed above, the beverage base may include a dairy product, such as acid whey. Dairy products, such as acid whey, may be susceptible to alterations of the flavor profile as a result of cooking and/or at least partially cooking. Accordingly, consistent with some embodiments, the temperature of the flash pasteurization may be low enough, and/or the time duration of the flash pasteurization may be short enough, to avoid substantially cooking the fermented beverage, and/or to avoid any notable degree of cooking of the fermented beverage.

According to an illustrative example embodiment, flash pasteurizing 42 the fermented beverage may include heating the fermented beverage to a temperature of about 160 degrees F. for about 15 seconds. It will, however, be appreciated that other temperatures and time durations may be utilized while still killing substantially all of the yeast (thereby arresting 14 the fermentation process), and while still retaining at least a portion of the lactic acid bacteria in the fermented beverage, and while preserving the flavor profile of the fermented beverage (e.g., by not substantially cooking the fermented acid whey).

Consistent with some embodiments, arresting the fermentation process may further include rapidly chilling 44 the flash pasteurized fermented beverage. For example, while the pasteurization temperature and/or pasteurization time duration may be selected to retain at least a portion of the lactic acid bacteria in the fermented beverage, and/or to preserve the flavor profile of the fermented beverage, a prolonged cooling time, post pasteurization, may result in the loss of live lactic acid bacteria in the fermented beverage and/or undesired changes in the flavor profile of the fermented beverage. Additionally, as the fermented beverage may include a dairy product, such as acid whey, a prolonged cooling time, post pasteurization may result in problems such as spoiling and/or the accumulation of unhealthy and/or dangerous bacteria within the fermented beverage. Accordingly, it may be desirable to rapidly chill 44 the pasteurized fermented beverage. A variety of arrangements may be utilized for rapidly chilling the fermented beverage, such as liquid-liquid heat exchangers, circulating the fermented beverage through a chiller and/or chilled conduits/pipe. It will be appreciated that a variety of additional and/or alternative mechanisms may be utilized for rapidly chilling 44 the fermented beverage. Consistent with some implementations, following pasteurization the fermented beverage may be rapidly chilled to a temperature of about 45 degrees F., although other temperatures may suitably be selected. Additionally, in some example embodiments, following rapid chilling to, e.g., around 45 degrees F., the fermented beverage may be further chilled down to a conventional food refrigeration temperature, e.g., of less than about 41 degrees F.

Consistent with some embodiments, additional flavorings may be added 16 to the fermented beverage after fermentation. For example, at least some flavoring ingredients may undergo an undesired change in flavor or flavor profile if they were to be fermented. Additionally and/or alternatively, at least some flavoring ingredients may contribute additional food for the fermentation process, e.g., which may result in an increase of the alcohol content in the fermented beverage above the desired alcohol content, and/or may require a shorter and/or lower temperature fermentation (e.g., as compared to fermenting the beverage base alone). In some instances, reducing the fermentation temperature and/or time to achieve a desired alcohol content when some flavoring ingredients are added before fermentation, may result in less fermentation of the beverage base (e.g., acid whey) itself. Less fermentation of the acid whey may, for example, decrease the production of lactic acid bacteria, decrease the lactose reduction of the beverage base, and/or alter the flavor or flavor profile in the final fermented beverage (e.g., as compared to fermenting the acid whey without the inclusion of such flavoring ingredients). Further, according to some example embodiments, at least some of the additional flavorings may be added 16 to the fermented beverage after pasteurization. Consistent with some such embodiments, adding 16 the additional flavorings after pasteurization may avoid heating, partially cooking, and/or substantially cooking the additional flavoring ingredients, e.g., which may undesirably change the flavor or flavor profile of at least some of the flavoring ingredients and/or of the flavored fermented beverage.

In various embodiments consistent with the present disclosure, a wide array of additional flavoring ingredients, and/or combinations of flavoring ingredients may be utilized. Illustrative examples of additional flavorings may include, but are not limited to, fruit flavoring, vegetable flavorings, herbs, botanicals, berries, and spices. In some particular examples, fruit and/or vegetable flavorings may be added as juices, purees, juice concentrate, essences and/or distillates. Illustrative examples of flavorings may include, but are not limited to: strawberry, watermelon, cantaloupe, blueberry, lemon, ginger (e.g., fresh, grated), mint (e.g., fresh), and turmeric (e.g., dried powder and/or juice), as well as various other natural and/or artificial flavorings. In some implementations, fruit and/or vegetable puree may be utilized as a flavoring ingredient, in which the puree may be made from fresh and/or frozen fruits and/or vegetable. In some implementations, additional sweeteners may also be added, e.g., to achieve a desired flavor or flavor profile, such as a balance of sweetness and acidity (e.g., which may, at least in part, arise from fermented acid whey, and/or one or more other added flavorings). Any variety of suitable sweeteners may be used. In some particular embodiments, honey may be used as a sweetener, e.g., which may provide some additional health benefits, which are thought to be available from honey. Consistent with some embodiments, combinations of flavorings may be utilized. Some illustrative examples of combinations of flavorings may include, but are not limited to, blueberry-ginger, cucumber-lime, peach-turmeric, etc. The content of the added flavorings in the beverage may vary widely. For example, in some embodiments the volume percent of fermented acid whey may range from between about 75% to about 90% or more of the total volume of the beverage, with the balance being additional flavorings and/or other ingredients. However, it will be appreciated that other content ranges may equally be utilized.

According to some embodiments consistent with the present disclosure, the fermented beverage may be filtered 18. Filtering 18 the fermented beverage may, for example, stabilize the fermented beverage and/or may control an alcohol content in the fermented beverage. For example, as generally described, in some implementations the fermented beverage may be, e.g., flash pasteurized to kill a substantial majority of the yeast fermenting the beverage base, thereby arresting 14 fermentation. However, it will be appreciated that, in some instances, at least a portion of the yeast may not be killed, resulting in some residual yeast in the fermented beverage. Further, in some instances the production process of a fermented beverage may include an “open” process, e.g., in which one or more of the production processes may result in the fermented beverage being exposed to open air at some point after pasteurization. As such, it may be possible that airborne yeast (e.g., wild yeast, and/or yeast particles from the addition of yeast for the fermentation process) may become incorporated into the fermented beverage, giving rise to some residual yeast in the fermented beverage. Further, in some situations additional added flavorings (such as fruits and/or vegetables) may include yeast (e.g., wild yeast that may have been on the skin of the fruit prior to juicing or pureeing). In such situations, residual yeast may be added to the fermented beverage after pasteurization. Any such residual yeast (e.g., yeast present in the fermented beverage after pasteurization) may, in some situations, continue, or reinitiate, fermenting the beverage. Such fermentation may destabilize the beverage, e.g., by changing a flavor or flavor profile of the beverage and/or an ingredient of the beverage, and/or may result in additional alcohol production that may elevate the alcohol content above the desired alcohol content.

With reference also to FIG. 4, in consideration of the foregoing possibility of the fermented beverage containing residual yeast, in some implementations, the fermented beverage may be filtered 18 to remove 50 at least a portion, a substantial portion, and/or all of the residual yeast. As such, filtering 18 the fermented beverage may stabilize the beverage and/or may control the alcohol content of the fermented beverage, e.g., by preventing and/or reducing additional, or subsequent, fermentation. Consistent with some illustrative example embodiments, filtering may effectively remove residual yeast (e.g., which may be expected to only be present in small amounts), without altering the flavor or flavor profile of the fermented beverage, and/or an ingredient of the fermented beverage, as may occur with a high temperature process, such as pasteurization. This may be particularly desirable, e.g., after the addition of flavorings, such as fruits and or vegetables, which may be susceptible to flavor alterations resulting from even relatively short durations of elevated temperature.

Additionally, in some illustrative example embodiments, as noted above, the fermented beverage may include lactic acid bacteria, which may be desirable. In some such embodiments, filtering 18 the fermented beverage may allow at least a portion, and/or a substantial portion, of the lactic acid bacteria to be retained 52 in the fermented beverage. Accordingly, the filtration process may be carried out in a manner to remove residual yeast, while allowing at least a portion of the lactic acid bacteria to be retained in the fermented beverage.

In addition to removing residual yeast (e.g., to reduce and/or prevent subsequent fermentation) and retaining lactic acid bacteria (e.g., which may provide a probiotic function for a consumer of the beverage), filtering 18 the fermented beverage may additionally and/or alternatively at least partially reduce 54 suspended sediment within the fermented beverage. For example, the fermented beverage may include various suspended sediments (e.g., particles that may, over time, settle out from the liquid phase of the fermented beverage). Such suspended sediments may include, but are not limited to, yeast particles, portions of favoring ingredients (e.g., particles of fruits or vegetables), as well as any other components that may eventually settle from the liquid phase of the fermented beverage. Filtering the fermented beverage to remove suspended sediment may, for example, avoid and/or reduce the accumulation of sediment in can, bottle, or the like, in which the fermented beverage may eventually be packaged. In some example embodiments, filtering 18 the fermented beverage may include at least partially clarifying 56 the fermented beverage. For example, in some illustrative example embodiments a fermented acid whey beverage may be provided having a somewhat opaque and/or at least partially translucent, but not totally clear, appearance. Consistent with some such embodiments, filtering 18 the fermented beverage may at least partially, but not completely, clarify the fermented beverage to achieve a desired aesthetic. Other implementations and aesthetics may equally be utilized.

Any suitable filtration techniques may be utilized to, e.g., remove residual yeast, retain at least a portion of lactic acid bacteria, at least partially reduce suspended sediment, and/or at least partially clarify the fermented beverage. According to one particular illustrative example embodiment, filtering 18 the fermented beverage may include processing the fermented beverage with a plate an frame filter. According to some example implementations, the plate and frame filter may include one or more filter elements having a pore size between about 3 microns to about 7 microns. Further, in some particular implementations, the plate and frame filter may include one or more filter elements having a pore size between about 3 microns to about 4 microns. Various additional and/or alternative filtration techniques may be utilized, including, but not limited to, processing the fermented beverage with a centrifuge, filtering the fermented beverage with a tube-in-tube filter, as well as various additional and/or alternative filtration techniques and/or combinations of filtration techniques.

As generally discussed above, in some illustrative example embodiments, the fermented beverage may include various bacteria, such as lactic acid bacteria, which may be beneficial for intestinal health, and the like, and/or may otherwise provide a probiotic effect. Further, in some embodiments, the inclusion of lactic acid bacteria may aid in prolonging an acceptable shelf life of the fermented beverage. For example, in some embodiments a fermented acid whey beverage may exhibit a useful cold-storage (e.g., at a temperature of about 34 degrees) shelf life of 90 days. In some particular embodiments a fermented acid whey beverage may exhibit a useful cold-storage shelf life of 120 day, or greater. It will be appreciated that the presence of lactic acid bacteria along may not be entirely responsible for the extended useful shelf life, but the presence of lactic acid bacteria is thought to aid in extending the useful shelf life.

For example, in some embodiments the acid whey may include lactic acid bacteria as a result of a process (e.g., filtered yogurt production, etc.) that generated the acid whey. In some embodiments, lactic acid bacteria may be generated as a result of the fermentation of the acid whey. In some particular embodiments that include filtering 18 the fermented beverage, filtering 18 may include retaining 52 at least a portion of the lactic acid bacteria in the fermented beverage. In consideration of the potential health benefits associated with consuming lactic acid bacteria, consistent with some example embodiments, lactic acid bacteria may be added 20 to the fermented beverage. The added 20 lactic acid bacteria may supplement any lactic acid bacteria that may already be present in the fermented beverage and/or may provide lactic acid bacteria in situations in which the fermented beverage has less than a desired amount of lactic acid bacteria. For example, even if the fermented beverage included at least some lactic acid bacteria a various points in the production of the fermented beverage, some, perhaps even a substantial amount, of the lactic acid bacteria may have been lost during production. For example, at least a portion of lactic acid bacteria in the fermented beverage may have been destroyed during pasteurization and/or may have been removed during filtration. As such, lactic acid bacteria may be added to the fermented beverage, which may supplement any lactic acid bacteria already present, and/or may replace at least a portion of lactic acid bacteria that may have been lost during production. Lactic acid bacteria added 20 to the fermented beverage may include any suitable lactic acid bacteria that may naturally arise in the fermented beverage, and/or may be suitable for the pH of the fermented beverage. Additionally, in some embodiments, multiple different strains of lactic acid bacteria may be added to the fermented beverage.

For example in some implementations, the addition of lactic acid bacteria may provide at least some degree of bio-preservation, e.g., particularly, but not exclusively, against yeast and molds, which may be prominent drivers of microbial spoilage. In some particular example embodiments, the added lactic acid bacteria may include fructophilic lactic acid bacteria for their impact on organoleptic properties of different matrix. One particular embodiment, the lactic acid bacteria may include Lyofast CRL 1505, available from Sacco System. In some testing, CRL 1505 was additionally observed to provide pleasant flavoring notes (e.g., sweet, milky, caramel, etc. depending on the matrix). Further clinical data has been provided for the use of the strain of lactic acid bacteria included in CRL 1505 as a probiotic. In some testing, the strain of bacteria in CRL 1505 has demonstrated a large spectrum of inhibition against yeast and molds and has been used in many countries around the world in dairy products, dairy-alternatives.

As generally discussed above, in some situations the fermentation of acid whey may result in the generation of at least some carbon dioxide. Further, in some embodiments at least a portion of the carbon dioxide generated from the fermentation of the acid whey may become entrained in the fermented beverage. This entrained carbon dioxide may provide some degree of carbonation and/or effervescence for the fermented beverage. In some illustrative example embodiments, whether any carbon dioxide has been entrained in the fermented beverage as a result of the fermentation process or not, the fermented beverage may be carbonated 22. In some illustrative example embodiments, the fermented beverage may be carbonated at a relatively low temperature. For example, in some embodiments the fermented beverage may be fermented at a temperature of about 32 degrees F. According to various implementations, fermentation may occur on a large scale (e.g., in a carbonation tank), and/or on a relatively smaller scale (e.g., in a keg). For example, in some suitable carbonation processes, the fermented beverage may undergo forced carbonation by maintaining the fermented beverage at a predetermined carbon dioxide volume and pressure for a three hour period. Consistent with some implementations, time, pressure, and temperature may be controlled during carbonation of a whey based beverage, for example, to reduce the occurrence of excessive foaming during canning process, and/or to achieve a desired volume of dissolved CO2 in finished product. Accordingly, time, pressure and temperature may be calibrated and monitored, including a “resting” period post carbonation and pre-canning. It will be appreciated that the carbonation parameters may be varied depending upon the degree of carbonation desired (e.g., anywhere from highly carbonated to lightly effervescent).

Following carbonation, in some example embodiments, the fermented beverage may be bottled 24. Bottling the fermented beverage may generally include any form of packaging, including sealing the fermented beverage in any suitable container, such as a can, a glass bottle, a plastic bottle, a keg, a box, or the like. Similar to most other processed during the production of the fermented beverage, bottling may occur at cold food storage temperatures (e.g., around 32 degrees F. to about 34 degrees F.). For example, other than during fermentation and pasteurization, the beverage base (e.g., acid whey) and the fermented beverage may generally be maintained at temperature below about 41 degrees F.

While various illustrative example embodiments have been described herein, it will be appreciated that such embodiments have been provided for the purpose of description and explanation, and are not intended to be limiting on the disclosed invention. For example, the various described embodiments include a variety of features and aspects and/or may provide a variety of advantages and applications. It will be appreciated that the features, aspects, advantages, and applications associated with the various embodiments are susceptible to various combinations in other embodiments consistent with the present disclosure. Accordingly, the inventions disclosed herein should not be limited by any of the disclosed embodiment, and are intended to encompass the full scope of the claims appended hereto.

What is claimed is:

1. A method of preserving a flavor profile of a fermented beverage comprising:
determining a desired alcohol content for the fermented beverage;
flash pasteurizing the fermented beverage to kill substantially all of a yeast used utilized for fermenting the fermented beverage; and
rapidly chilling the flash pasteurized fermented beverage.

2. The method according to claim 1, wherein the desired alcohol content is below about 0.5% alcohol by volume (ABV).

3. The method according to claim 1, wherein flash pasteurizing the fermented beverage terminates the fermentation process.

4. The method according to claim 1, wherein the fermented beverage contains lactic acid bacteria, and wherein flash pasteurizing the fermented beverage does not kill at least a portion of the lactic acid bacteria.

5. The method according to claim 4, wherein flash pasteurizing the fermented beverage does not kill a majority of the lactic acid bacteria.

6. The method according to claim 1, wherein the fermented beverage includes a fermented diary-based beverage, and wherein flash pasteurizing the beverage does not cook the fermented beverage.

7. The method according to claim 6, wherein the fermented beverage is a fermented acid whey beverage.

8. The method according to claim 6, wherein rapidly chilling the fermented beverage prevents spoiling of the dairy-based beverage.

9. The method according to claim 1, wherein flash pasteurizing the fermented beverage includes maintaining the fermented beverage at a temperature of about 160 degrees F. for about 15 seconds.

10. The method according to claim 1, wherein rapidly chilling the fermented beverage includes rapidly chilling the fermented beverage to a temperature of about 45 degrees F.

11. The method according to claim 10, further comprising subsequently chilling the fermented beverage to a temperature equal to, or less than, about 41 degrees F.

12. A method for controlling an alcohol content in a beverage comprising:
fermenting a beverage base;
determining that the fermented beverage base has achieved a desired alcohol content; and
flash pasteurizing the beverage base to kill substantially all of a yeast utilized for fermenting the beverage base.

13. The method according to claim 12, wherein the beverage base includes acid whey.

14. The method according to claim 13, wherein flash pasteurizing the beverage base does not cook the acid whey.

15. The method according to claim 12, further comprising rapidly cooling the pasteurized beverage base to a temperature of about 45 degrees F.

16. The method according to claim 15, further comprising cooling the pasteurized beverage base to a temperature of about 41 degrees F.

17. The method according to claim 12, wherein the desired alcohol content is below about 0.5% alcohol by volume (ABV).

18. The method according to claim 12, wherein fermenting the beverage base includes generating lactic acid bacteria within the beverage base.

19. The method according to claim 12, wherein flash pasteurizing the beverage does not kill at least a portion of the lactic acid bacteria within the beverage base.

20. The method according to claim 12, wherein flash pasteurizing the beverage base includes heating the beverage base to a temperature of about 160 degrees F. for about 15 seconds.
